(19) United States
(12) Patent Application Publication
(10) Pub. No.: US 2005/0128023 A1
(43) Pub. Date: Jun. 16, 2005

(54) Non-reciprocal circuit device having small absolute value of temperature coefficient of out-of-band attenuation and small absolute value of temperature coefficient of maximum- isolation frequency

(75) Inventors: Toshio Takahashi, Niigata-ken (JP); Hitoshi Onishi, Niigata-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/004,521

(22) Filed: Dec. 3, 2004

(30) Foreign Application Priority Data
Dec. 16, 2003 (JP) 2003-417964

(51) Int. Cl. H01P 1/36

(52) U.S. Cl. 333/24.2; 333/1.1; 330/253

(57) ABSTRACT

A non-reciprocal circuit device includes a magnetic disk; a plurality of central conductors intersecting each other on a surface of the magnetic disk; a plurality of matching capacitors connected to the respective central conductors; and an SmCO-based or AlNiCo-based magnet that is stacked on the magnetic disk, the SmCO-based or AlNiCo-based magnet applying a bias magnetic field to the magnetic disk. The magnetic disk is composed of garnet ferrite represented by any one of the following Formulae (1) to (3):
Y₃₋ₓGdₓFe_{t-2y-z}Co_{y}Si_{y}Al_{z}O₁₂ (1)
Y₃₋ₓ₋ᵤGdₓCaᵤFe_{t-2y-u-z}Co_{y}Si_{y}DᵤAl_{z}O₁₂ (2)
Y₃₋ₓGdₓFe_{t-2y-v-z}Co_{y}Si_{y}InᵥAl_{z}O₁₂ (3)

### BACKGROUND OF THE INVENTION

1. Field of the Invention

The present invention relates to non-reciprocal circuit devices and communication devices, which are used in a high-frequency band such as a microwave band, and in particular, relates to a non-reciprocal circuit device having a small absolute value of a temperature coefficient of out-of-band attenuation and a small absolute value of a temperature coefficient of maximum-isolation frequency.

2. Description of the Related Art

An isolator, a type of lumped-constant non-reciprocal circuit device, is a high-frequency component that transmits signals in the transmission direction without loss and prevents signals from passing through in the reverse direction, and is used in transmitters of mobile communication devices such as mobile phones.

An isolator includes a magnetic yoke that accommodates a magnetic assembly having a magnetic disk composed of ferrite and the like assembled with a plurality of central conductors and a common electrode, a biasing magnet, matching capacitors, and a terminal resistive device. Recently, isolators have been built into small mobile phones used in a high-frequency band ranging from several hundreds of megahertz to several gigahertz. Thus, isolators of several millimeters per side have been developed in response to a reduction in size and an improvement in functionality of mobile phones.

In general, a magnetic disk built into an isolator is composed of yttrium-iron-garnet (YIG) ferrite to reduce insertion loss. A biasing magnet built into an isolator is composed of, for example, a ferrite magnet, a neodymium-iron-boron magnet, or a samarium-cobalt magnet (SmCo-based magnet). An SmCo-based magnet is promising for use in an isolator because it exhibits high residual magnetization and has a small absolute value of a temperature coefficient of residual magnetization. A non-reciprocal circuit device including YIG ferrite, an SmCo-based magnet, and a capacitor composed of a PbZrO-based dielectric material is disclosed in Japanese Unexamined Patent Application Publication No. 11-283821 (Patent Document 1).

In general, this PbZrO-based dielectric material has a small relative dielectric constant of 140 or less and comparatively small capacitance. Thus, when the non-reciprocal circuit device disclosed in Patent Document 1 operates in a frequency band ranging from several hundreds of megahertz to several gigahertz, the inductance of a central conductor must be increased due to the small capacitance C. However, when the inductance is increased, out-of-band attenuation at 2fo in the non-reciprocal circuit device is reduced. When the out-of-band attenuation is reduced, signals easily leak in the frequency band around 2fo. This causes generation of noise from an antenna of a communication device.

Moreover, the composition of a magnetic rotator (YIG ferrite) disclosed in Patent Document 1 is optimized for use with a capacitor composed of a PbZrO-based dielectric material.

### SUMMARY OF THE INVENTION

In order to solve the problems described above, it is an object of the present invention to provide a non-reciprocal circuit device having high out-of-band attenuation, a small absolute value of a temperature coefficient of out-of-band attenuation, and a small absolute value of a temperature coefficient of maximum-isolation frequency.

To achieve the object described above, the present invention adopts the structure described below.

A non-reciprocal circuit device according to the present invention includes a magnetic disk; a plurality of central conductors intersecting each other on a surface of the magnetic disk; a plurality of matching capacitors connected to the respective central conductors; and an SmCO-based or AlNiCo-based magnet that is stacked on the magnetic disk, the SmCO-based or AlNiCo-based magnet applying a bias magnetic field to the magnetic disk. The magnetic disk is composed of garnet ferrite represented by the following formula:
Y₃₋ₓGdₓFe_{t-2y-z}Co_{y}Si_{y}Al_{z}O₁₂
where 0.2≦x≦1.5, 0.005≦y≦0.015, 0≦z≦1.5, and 4.75≦t≦5, each of x, y, z, and t indicating a ratio in the formula.

Preferably, x, y, z, and t lie in the following ranges: 0.2≦x≦1.25, 0.005≦y≦0.01, 0≦z≦1.5, and 4.75≦t≦4.9.

Alternatively, a non-reciprocal circuit device according to the present invention may include a magnetic disk; a plurality of central conductors intersecting each other on a surface of the magnetic disk; a plurality of matching capacitors connected to the respective central conductors; and an SmCO-based or AlNiCo-based magnet that is stacked on the magnetic disk, the SmCO-based or AlNiCo-based magnet applying a bias magnetic field to the magnetic disk. The magnetic disk is composed of garnet ferrite represented by the following formula:
Y₃₋ₓ₋ᵤGdₓCaᵤFe_{t-2y-u-z}Co_{y}Si_{y}DᵤAl_{z}O₁₂
where D is at least one element selected from Zr, Hf, and Sn, and 0.2≦x≦1.5, 0.005≦y≦0.015, 0≦z—1.5, 4.75≦t≦5, and 0<u≦0.3, each of x, y, z, t, and u indicating a ratio in the formula.

Preferably, x, y, z, t, and u lie in the following ranges: 0.2≦x≦1.25, 0.005≦y 0.01, 0≦z≦1.5, 4.75≦t≦4.9, and 0.04≦u≦0.2.

Alternatively, a non-reciprocal circuit device according to the present invention may include a magnetic disk; a plurality of central conductors intersecting each other on a surface of the magnetic disk; a plurality of matching capacitors connected to the respective central conductors; and an SmCO-based or AlNiCo-based magnet that is stacked on the magnetic disk, the SmCO-based or AlNiCo-based magnet applying a bias magnetic field to the magnetic disk. The magnetic disk is composed of garnet ferrite represented by the following formula:
Y₃₋ₓGdₓFe_{t-2y-v-z}Co_{y}Si_{y}InᵥAl_{z}O₁₂
where 0.2≦x≦1.5, 0.005≦y≦0.015, 0≦z≦1.5, 4.75≦t≦5, and 0<v≦0.2, each of x, y, z, t, and v indicating a ratio in the formula.

Preferably, x, y, z, t, and v lie in the following ranges: 0.2≦x≦1.25, 0.005≦y≦0.01, 0≦z≦1.5, 4.75≦t≦4.9, and 0.04≦v≦0.2.

The SmCo-based magnet described above is mainly composed of SmCO₅, Sm₂Co₁₇, or Sm(Co, Cu, Fe, M)_{z}, where M is at least one element selected from Ti, Zr, and Hf, and 6.8≦z≦7.6. The temperature coefficient of residual magnetization of each of these SmCo-based magnets differs depending on the composition but preferably has a value between −0.03 and −0.05%/K, and most preferably about −0.04%/K.

The AlNiCo-based magnet described above is mainly composed of Fe₅₁Al₈Ni₁₄CO₂₄Cu₃ or Fe₃₄Al₇Ni₁₅CO₃₅Cu₄Ti₅, where the subscripts indicate mass percent. The temperature coefficient of residual magnetization of each of these AlNiCo-based magnets preferably has a value between about 0.01 and −0.02%/K.

The absolute value of the temperature coefficient (α) of saturation magnetization 4πMs of the garnet ferrite described above can be reduced by addition of Gd in the ranges described above. The absolute value of the temperature coefficient of out-of-band attenuation and the absolute value of the temperature coefficient of maximum-isolation frequency can be reduced by the use of the garnet ferrite having a small a and the SmCo-based magnet having a small temperature coefficient of residual magnetization.

The half-width of the ferromagnetic resonance (ΔH) can be reduced to reduce insertion loss by adding Co and Si in the content described above into the garnet ferrite, as compared with the case where Gd alone is added (Y—Gd—Fe—Al—O— based garnet ferrite).

The value of 4πMs can be adjusted by changing the quantity of added Al in the ranges described above. A single garnet phase can be formed without formation of a different phase by adjusting the sum of Fe, Co, Si, and Al in the ranges described above to reduce ΔH.

The half-width of the ferromagnetic resonance (ΔH) can further be reduced by adding Ca and D in the content described above in addition to Co and Si, as compared with the case where Gd alone is added.

Moreover, the half-width of the ferromagnetic resonance (ΔH) can be reduced by adding In in the content described above in addition to Co and Si, as compared with the case where Gd alone is added.

In the present invention, out-of-band attenuation is the quantity of loss at a frequency 2fo, that is, twice fo, which is the center frequency of isolation (the operating frequency of a non-reciprocal circuit device).

The absolute value of the temperature coefficient of out-of-band attenuation is the absolute value of the rate of change of out-of-band attenuation with respect to temperature. The absolute value of the temperature coefficient of center isolation frequency is the absolute value of the rate of change of the center frequency with respect to temperature.

The half-width of the ferromagnetic resonance (ΔH) described above is the half-width of the imaginary part μ″ of the magnetic permeability at the peak. The magnetic permeability of a magnetic body is ordinarily measured in the direction in which a magnetic field is applied. On the other hand, in this case the magnetic permeability when a high frequency magnetic field is applied in the direction at right angles to the direction of a static magnetic field is measured in a saturated static magnetic field. Then, the half-width of the ferromagnetic resonance (ΔH) is derived from a measured value of the imaginary part. A small half-width of ferromagnetic resonance (ΔH) means low loss.

The temperature coefficients of magnetization α(−35) and α(85) are derived from the following calculations.
α(−35)=[{4πMs(25° C.)−4πMs(−35° C.)}/4πMs(25° C.)]×(100/60)[%·° C.⁻¹]; and
α(85)=[{4πMs(85° C.)−4πMs(25° C.)}/4πMs(25° C.)]×(100/60)[%·° C.⁻¹]
where 4πMs(−35° C.), 4πMs(25° C.), and 4πMs(85° C.) are the values of saturation magnetization 4πMs of a magnetic disk at −35° C., 25° C., and 85° C., respectively.

In the non-reciprocal circuit device according to the present invention, each of the matching capacitors preferably includes a dielectric material having a relative dielectric constant of 150 or more. More preferably, the dielectric is composed of barium titanate.

In the non-reciprocal circuit device described above, the capacitance C can be comparatively large because each of the matching capacitors contains a dielectric material having a relative dielectric constant of 150 or more. Thus, when the non-reciprocal circuit device operates in a frequency band ranging from several hundreds of megahertz to several gigahertz, the inductance L of the central conductors can be reduced because the capacitance C is large. The out-of-band attenuation at 2fo can be increased by reducing the inductance L, so that the signals at the frequency 2fo can be prevented from passing through, thereby preventing unwanted signals from passing through to suppress noise.

Since barium titanate does not contain a toxic element, such as Pb, environmental pollution does not occur.

In the non-reciprocal circuit device according to the present invention, the magnetic disk, the plurality of central conductors, the plurality of matching capacitors, and the SmCO-based or AlNiCo-based magnet are preferably housed in an approximately-rectangular-parallelepiped magnetic yoke of 3.2 mm or less per side, as viewed from the top.

In a communication device including the non-reciprocal circuit device described above, the out-of-band attenuation is high, and the absolute values of a temperature coefficient of out-of-band attenuation and a temperature coefficient of maximum-isolation frequency are small. Thus, fluctuations in the characteristic of the communication device in the operating environment can be reduced, thereby achieving a stable performance. Moreover, the non-reciprocal circuit device has high out-of-band attenuation, so that the antenna of the communication device does not produce noise.

The non-reciprocal circuit device according to the present invention preferably includes the AlNiCo-based magnet applying a bias magnetic field to the magnetic disk. The temperature coefficient of residual magnetization of the AlNiCo-based magnet preferably has a value between about 0.01 and −0.02%/K. The absolute value of the temperature coefficient of out-of-band attenuation and the absolute value of the temperature coefficient of maximum-isolation frequency can be reduced by adopting the garnet ferrite having a small temperature coefficient α and the AlNiCo-based magnet having a small temperature coefficient of residual magnetization.

### BRIEF DESCRIPTION OF THE DRAWINGS

FIG. 1 is an exploded perspective view of an isolator according to an embodiment of the present invention; and

FIG. 2 is a circuit diagram illustrating a circuit configuration of a mobile phone including an isolator according to the present invention.

### DESCRIPTION OF THE PREFERRED EMBODIMENTS

Referring to the drawings, embodiments of the present invention will now be described. In all the drawings, the scale of each element may be different from that in an actual product in order to ensure accurate understanding of the details of the embodiments.

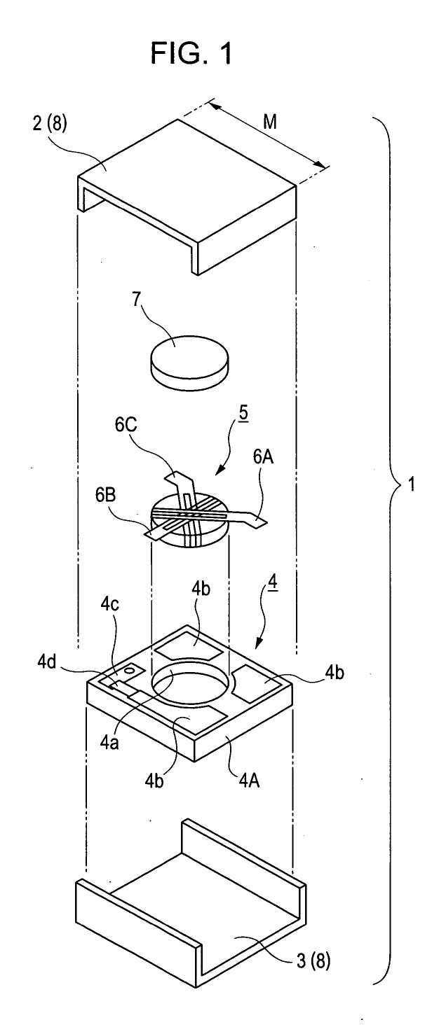

FIG. 1 is an exploded perspective view illustrating an embodiment of an isolator (non-reciprocal circuit device) according to the present invention. An isolator 1 according to the embodiment includes an upper case 2 and a lower case 3; and a substrate 4, a magnetic disk 5, central conductors 6A, 6B, and 6C electrically connected to a common electrode at the lower side of the magnetic disk 5, and a discoid magnet 7 composed of an SmCo-based or an AlNiCo-based hard magnetic material, in this order from the position of the lower case 3, these being retained between the upper case 2 and the lower case 3.

Each of the upper case 2 and the lower case 3 is a U-shaped case, as viewed from the side, composed of a magnetic material. An approximately-rectangular-parallelepiped magnetic yoke 8 is formed by integrating the upper case 2 and the lower case 3. The size M of each side of the magnetic yoke 8 is 3.2 mm or less.

The substrate 4 includes a resin base 4A that has a hole 4a passing through the center of the base 4A, patterned electrodes (matching capacitors) 4b formed on three edges of a surface of the substrate 4, a ground electrode 4c formed on another edge on the surface of the substrate 4, and a resistive device 4d electrically connected to the ground electrode 4c and one of the patterned electrodes 4b.

The magnetic disk 5 is composed of garnet ferrite. The central conductors 6A, 6B, and 6C, each composed of a metal strip, extend around the circumference of the magnetic disk 5 at intervals of 60 degrees in the circumferential direction of the magnetic disk 5. The magnetic disk 5 is disposed in the hole 4a of the substrate 4, so that first ends of the central conductors 6A, 6B, and 6C are electrically connected to respective patterned electrodes 4b, and all second ends of the central conductors 6A, 6B, and 6C are connected to the common electrode (not shown in the drawing). The discoid SmCo-based magnet 7, which applies a bias magnetic field in the vertical direction of the magnetic disk 5, is stacked on the central conductors 6A, 6B, and 6C. The isolator 1 is composed of all these elements, in this state, retained between the upper case 2 and the lower case 3.

The SmCo-based magnet 7 is mainly composed of SmCo₅, Sm₂CO₁₇, or Sm(Co, Cu, Fe, M)_{z}, where M is at least one element selected from Ti, Zr, and Hf, and 6.8≦z≦7.6. The temperature coefficient of residual magnetization of each of these SmCo-based magnets differs depending on the composition but preferably has a value between −0.03 and −0.05%/K, and most preferably about −0.04%/K. The AlNiCo-based magnet 7 is mainly composed of Fe₅₁Al₈Ni₁₄CO₂₄Cu₃ or Fe₃₄Al₇Ni₁₅Co₃₅Cu₄Ti₅, where the subscripts indicate mass percent. The temperature coefficient of residual magnetization of each of these AlNiCo-based magnets preferably has a value between about 0.01 and −0.02%/K.

The temperature coefficient of residual magnetization set in the range described above is consistent with a temperature coefficient of 4πMs of the magnetic disk 5. Thus, the absolute value of the temperature coefficient of out-of-band attenuation and the absolute value of the temperature coefficient of maximum-isolation frequency can be decreased, particularly in a temperature range of 25° C. to 85° C.

Each of the patterned electrodes (matching capacitors) 4b preferably includes a dielectric having a relative dielectric constant of 150 or more. In particular, the dielectric is preferably composed of barium titanate (BaTiO₃). The isolator 1 including such a dielectric can have matching capacitors with comparatively large capacitance. Thus, out-of-band attenuation at 2fo can be increased by decreasing the inductance L of the central conductors. The size of the isolator 1 can be reduced because sufficient capacitance can be obtained even when the size of the capacitors is reduced due to a comparatively large relative dielectric constant of 150 or more. In particular, an isolator of 3.2 mm or less per side can be easily formed.

The composition of the garnet ferrite composing the magnetic disk 5 will now be described.

The magnetic disk 5 is composed of garnet ferrite represented by Formula (1): Y₃₋ₓGdₓFe_{t-2y-z}Co_{y}Si_{y}Al_{z}O₁₂, where 0.2≦x≦1.5, 0.005≦y≦0.015, 0≦z≦1.5, and 4.75≦t≦5, each of x, y, z, and t indicating a ratio in Formula (1).

Preferably, x, y, z, and t lie in the following ranges: 0.2≦x≦1.25, 0.005≦y≦0.01, 0≦z≦1.5, and 4.75≦t≦4.9.

When the magnetic disk 5 is composed of the garnet ferrite represented by Formula (1), the sum of the ratios of Y and Gd is 3, and the ratio of Y ranges from 1.5 to 2.8.

An absolute value of a temperature coefficient (α) of 4πMs can be reduced by setting the ratio of Gd in the range of 0.2 to 1.5. Since the temperature coefficient of surface magnetic flux of the SmCo-based magnet 7 used in the isolator 1 has a negative value, the temperature coefficient of 4πMs around room temperature can be negative, approximately 0, or exactly 0 by setting the ratio of Gd in the range of 0.2 to 1.5. The ratio of Gd is preferably 1.25 or less to maintain the half-width of the ferromagnetic resonance (ΔH) at a low value of 6,000 A/m or less.

When the ratio of Gd is 1.0 or less, a of the magnetic disk 5 can be maintained below zero in the overall temperature range. Thus, a of the magnetic disk 5 and the temperature coefficient of the surface magnetic flux of the SmCo-based magnet 7 have the same sign (minus). Since 4πMs of the magnetic disk 5 and the surface magnetic flux of the SmCo-based magnet 7 increase and decrease according to temperature change in the same way, stability of the isolator 1 can be improved.

It is preferable that the ratio of Gd be not less than 0.2 because reduction of ΔH by adding Co—Si cannot be achieved.

ΔH can be reduced by adjusting the ratio of each of Co and Si to 0.005 to 0.015. The ratio of each of Co and Si is preferably from 0.005 to 0.01 to reliably reduce ΔH. When the ratio of each of Co and Si exceeds 0.015, ΔH is increased. When the ratio of each of Co and Si is less than 0.005, ΔH cannot be reduced.

The value of 4πMs can be adjusted by adjusting the ratio of Al to 0 to 1.5. When the ratio of Al exceeds 1.5, 4πMs becomes 0. Thus, the upper limit of the ratio of Al is preferably set to 1.5 to achieve a practical magnitude of 4πMs.

The sum of the ratios of Fe, Co, Si, and Al is t. A single garnet phase can be formed without formation of a different phase by adjusting the ratio t to 4.75 to 5 to reduce ΔH. When the ratio t is less than 4.75 or over 5, the magnetic disk 5 does not have a single garnet phase but has a different phase, thereby-increasing ΔH abruptly. The ratio t is preferably adjusted to 4.75 to 4.9 to further reduce ΔH.

The range of the sum of the ratios of Fe, Co, Si, and Al is from 4.75 to 5, preferably, from 4.75 to 4.9. When the ratio of Fe is less than 5, ΔH is decreased. When the ratio of Fe is less than 4.75, ΔH is obviously increased, thus becoming worse.

The magnetic disk 5 may be composed of garnet ferrite represented by Formula (2): Y₃₋ₓ₋ᵤGdₓCaᵤFe_{t-2y-u-z}Co_{y}Si_{y}DᵤAl_{z}O₁₂, where D is at least one element selected from Zr, Hf, and Sn, and 0.2≦x≦1.5, 0.005≦y≦0.015, 0≦z≦1.5, 4.75≦t≦5, and 0<u≦0.3, each of x, y, z, t, and u indicating a ratio in Formula (2).

Preferably, x, y, z, t, and u lie in the following ranges: 0.2≦x≦1.25, 0.005≦y≦0.01, 0≦z≦1.5, 4.75≦t≦4.9, and 0.04≦u≦0.2.

When the magnetic disk 5 is composed of the garnet ferrite represented by Formula (2), the sum of the ratios of Y, Gd, and Ca is 3, and the ratio of Y ranges from 1.2 to 2.76.

The ratio of each of Ca and D is preferably in the range of more than 0 to 0.3 to reliably reduce ΔH. When the ratio of each of Ca and D exceeds 0.3, ΔH cannot be reduced any more but the absolute value of α is increased. The ratio of each of Ca and D is preferably 0.04 to 0.2 to attain a balance between low a and low ΔH. The ratio of each of Ca and D is preferably 0.1 to 0.16 to reduce ΔH and the absolute value of α.

The sum of the ratios of Fe, Co, Si, D, and Al is t. A single garnet phase can be formed without formation of a different phase by adjusting the ratio t to 4.75 to 5 to reduce ΔH.

The range of the sum of the ratios of Fe, Co, Si, D, and Al is from 4.75 to 5, preferably, from 4.75 to 4.9.

The magnetic disk 5 may be composed of garnet ferrite represented by Formula (3): Y₃₋ₓGdₓFe_{t-2y-v-z}Co_{y}Si_{y}InᵥAl_{z}O₁₂, where 0.2≦x≦1.5, 0.005≦y≦0.015, 0≦z≦1.5, 4.75≦t≦5, and 0<v≦0.2, each of x, y, z, t, and v indicating a ratio in Formula (3).

Preferably, x, y, z, t, and v lie in the following ranges: 0.2≦x≦1.25, 0.005≦y≦0.01, 0≦z≦1.5, 4.75≦t≦4.9, and 0.04≦v≦0.2.

ΔH can be reduced by setting the ratio of In in the range of more than 0 to 0.2. The ratio of In is preferably 0.04 to 0.2 to reliably reduce ΔH. When added In exceeds 0.2, ΔH cannot be reduced any more but the absolute value of a is increased. It is preferable that the ratio of In be 0.04 to 0.2 and In be added with Gd, to attain a balance between low a and low ΔH. The ratio of In is preferably 0.1 to 0.16 to reduce ΔH and the absolute value of a.

The sum of the ratios of Fe, Co, Si, In, and Al is t. A single garnet phase can be formed without formation of a different phase by adjusting the ratio t to 4.75 to 5 to reduce ΔH.

The range of the sum of the ratios of Fe, Co, Si, In, and Al is from 4.75 to 5, preferably, from 4.75 to 4.9.

When the magnetic disk 5 represented by any one of Formulae (1) to (3) is used, the absolute value of a can be reduced and ΔH can be maintained at 6,000 A/m or less. Furthermore, even when the magnetic disk 5 has the same α as known garnet ferrite, ΔH in the magnetic disk 5 can be lower than that in the known garnet ferrite 4πMs can be set to a value suitable for use in a high-frequency region by adjusting the quantity of Al. When the magnetic disk 5 combined with the SmCo-based magnet 7 is used as the isolator 1, the temperature characteristic of the SmCo-based magnet 7 can be compensated by adjusting the quantity of Gd.

As described above, the isolator 1 according to the embodiments has high out-of-band attenuation, a small absolute value of a temperature coefficient of out-of-band attenuation, and a small absolute value of a temperature coefficient of maximum-isolation frequency. Moreover, the magnetic disk 5 has low ΔH, which leads to reduced insertion loss.

An embodiment of a method for manufacturing the magnetic disk 5 will now be described.

First, oxide powders of constituent elements of a predetermined composition are prepared and mixed to manufacture the magnetic disk 5. For example, powders of Y₂O₃, Gd₂O₃, Fe₂O₃, Co₃O₄, SiO₂, and Al₂O₃ are prepared as raw materials for manufacturing Y—Gd—Fe—Co—Si—Al—O-based garnet ferrite. Powders of Y₂O₃, CaCO₃, Fe₂O₃, CO₃O₄, SiO₂, SnO₂ or ZrO₂ or HfO₂, and Al₂O₃ are prepared as raw materials for manufacturing Y—Ca—Fe—Co—Si-D(Sn, Zr, or Hf)—Al—O-based garnet ferrite. Powders of Y₂O₃, Gd₂O₃, Fe₂O₃, CO₃O₄, SiO₂, In₂O₃, and Al₂O₃ are prepared as raw materials for manufacturing Y—Gd—Fe—Co—Si—In—Al—O-based garnet ferrite.

Here, the compositions of garnet ferrite devices are represented by Formulae (1) to (3).

These powders are preferably used as raw materials. These powders are weighed so as to attain a predetermined ratio. When raw materials used are grains or pellets, instead of powders, these raw materials are mixed, and then pulverized in, for example, a ball mill or an attritor. It is preferable that a portion of the mill or the attritor in contact with a mixed powder do not contain Fe to prevent contamination of the mixed powder by Fe.

After the above mixture is dried, the dried mixture is calcined in air or an atmosphere of oxygen at a temperature in the range of about 1,000° C. to about 1,200° C. for a predetermined time, for example, several hours to obtain a calcined powder (calcine).

This calcined powder (calcine) is pulverized in a ball mill or an attritor. It is preferable that a portion of the pulverizing device in contact with the calcined powder do not contain Fe to prevent contamination of the calcined powder by Fe.

After the calcined powder is pulverized into a uniform particle size, this powder is molded with binder under a pressure of about 1 t/cm² into a predetermined shape, for example, a discoid shape, a plate shape, or a prismatic shape. This molding is sintered at a temperature in the range of about 1,350° C. to about 1,500° C. into the magnetic disk 5.

Alternatively, the pulverized powder having a uniform particle size may be molded in substantially the same shape as the final shape and then sintered. Then, a magnetic disk in the final shape is cut out from this sinter.

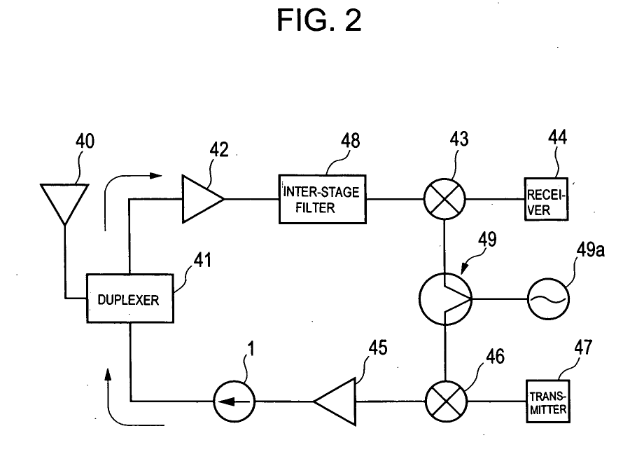

FIG. 2 illustrates a typical circuit configuration of a mobile phone (communication device) including the isolator 1 according to the embodiments. An antenna duplexer 41 is connected to an antenna 40; a receiver (intermediate-frequency (IF) circuit) 44 is connected to the output of the antenna duplexer 41 through a selector (mixer) 43, an inter-stage filter 48, and a low-noise amplifier 42; a transmitter (IF circuit) 47 is connected to the input of the antenna duplexer 41 through a selector (mixer) 46, a power amplifier 45, and the isolator 1; and a local oscillator 49a is connected to the selectors 43 and 46 through a distribution transformer 49.

This isolator 1 is used in the circuit of the mobile phone shown in FIG. 2. The isolator 1 transmits signals with low loss to the antenna duplexer 41 and prevents signals from passing through in the reverse direction by increasing the loss of the signals. Thus, the isolator 1 prevents unwanted signals, such as noise, from reversely passing through to the side of the amplifier 45.

The above mobile phone includes the isolator 1 having a small absolute value of a temperature coefficient of out-of-band attenuation and a small absolute value of a temperature coefficient of maximum-isolation frequency. Thus, fluctuations in the characteristic of the mobile phone in the operating environment can be reduced, thereby achieving a stable performance. Moreover, the isolator 1 has high out-of-band attenuation, so that the antenna of the mobile phone does not produce noise.

### EXAMPLES

### Experiment 1

Isolators of 3.2 mm per side as shown in FIG. 1 were prepared in Examples 1 to 3, and Comparative Examples 1 to 6 to examine fluctuations in center frequencies of isolation values and fluctuations in out-of-band attenuation. The temperature coefficients (α) of 4πMs of magnetic disks used in the isolators were also examined.

### Example 1

A magnetic disk composed of YIG ferrite and having an approximately-hexagonal shape, as viewed from the top, of about 1.5 mm long by about 2.47 mm wide by 0.35 mm thick was used as a magnetic disk 5. An SmCo-based magnet composed of Sm₂(CoFeCu)₁, was used as a biasing magnet. BHmax, the residual magnetization Br, the coercive force bHc, and the temperature coefficient of residual magnetization in the range of 25° C. to 85° C. of the SmCo-based magnet were respectively 191 kJ/m³, 1.05 T, 636 kA/m, and −0.04%/° C. An isolator of Example 1 as shown in FIG. 1 was prepared with these magnetic disk and magnet. The composition of the magnetic disk is shown in Table I. A matching capacitor connected to a central conductor at the input side was composed of a dielectric material of barium titanate and had a capacitance C₁ of 12.3 pF, a matching capacitor connected to a central conductor at the output side had a capacitance C₂ of 12.2 pF, and a matching capacitor connected to a terminating resistor in parallel had a capacitance C₃ of 26.7 pF. The terminal resistance was 68 Ω.

### Example 2

An isolator of Example 2 was prepared as in Example 1 except that the composition of the magnetic disk 5 was changed. The composition of the magnetic disk is shown in Table I.

### Example 3

An isolator of Example 3 was prepared as in Example 1 except that the composition of the magnetic disk 5 was changed and an AlNiCo-based magnet composed of Fe₅₁Al₈Ni₁₄CO₂₄Cu₃, where the subscripts indicate mass percent, was used as a biasing magnet. The composition of the magnetic disk is shown in Table I.

### Comparative Examples 1 to 6

Each of isolators of Comparative Examples 1 to 6 was prepared as in Example 1 except that the composition of the magnetic disk 5 was changed and a ferrite magnet was used as a biasing magnet. In each of Comparative Examples, BHmax, the residual magnetization Br, the coercive force bHc, and the temperature coefficient of residual magnetization in the range of 25° C. to 85° C. of the ferrite magnet were respectively 30 kJ/m³, 0.4 T, 260 kA/m, and −0.18%/° C. The composition of the magnetic disk is shown in Table I.

Regarding the isolators of Examples 1 to 3, and Comparative Examples 1 to 6, fluctuations in center frequencies of isolation values and fluctuations in out-of-band attenuation were examined. The temperature coefficients (α) of 4πMs of the magnetic disks used in the isolators were also examined. Table I shows the results.

The fluctuations in center frequencies of isolation values shown in FIG. 1 are those in the range of 25° C. to 85° C., and the fluctuations in out-of-band attenuation are those in the range of 25° C. to 85° C. The temperature coefficients (α(−35)) of the magnetic disks are temperature coefficients of 4πMs in the range of −35° C. to 25° C. The temperature coefficients (α(85)) of the magnetic disks are temperature coefficients of 4πMs in the range of 25° C. to 85° C.

TABLE I

| | | | Temperature | | | |
|---|---|---|---|---|---|---|
| | | | Characteristic of | | Fluctuation in | |
| | | | Magnetic Disk | | Center Isolation | Fluctuation in |
| | | | α(−35) | α(85) | Frequencies | Out-of-band |
| Example | Composition of Magnetic Disk | Magnet | (%/° C.) | (%/° C.) | (MHZ) | Attenuation (dB) |
| Example 1 | Y_{1.75}Gd_{1.25}Fe_{4.853}Co_{0.01}Si_{0.01}Al_{0.01}O₁₂ | SmCo | +0.07 | −0.08 | +21.5 | −0.8 |
| Example 2 | Y_{1.72}Gd_{1.28}Fe_{4.863}Co_{0.01}Si_{0.01}O₁₂ | SmCo | +0.05 | −0.06 | +26.0 | −1.2 |
| Example 3 | Y_{1.65}Gd_{1.35}Fe_{4.863}Co_{0.01}Si_{0.01}O₁₂ | AlNiCo | +0.03 | −0.07 | +19.5 | −0.71 |
| Comparative | Y_{2.3}Gd_{0.7}Fe_{4.463}Co_{0.1}Sn_{0.1}Al_{0.32}O₁₂ | Ferrite | −0.15 | −0.22 | +19.0 | −5.3 |
| Example 1 | | | | | | |
| Comparative | Y_{2.4}Gd_{0.6}Fe_{4.613}Co_{0.01}Si_{0.25}O₁₂ | Ferrite | −0.14 | −0.19 | +11.0 | −4.7 |
| Example 2 | | | | | | |
| Comparative | Y_{2.3}Gd_{0.7}Fe_{4.483}In_{0.1}Al_{0.3}O₁₂ | Ferrite | −0.16 | −0.22 | +20.5 | −6.0 |
| Example 3 | | | | | | |
| Comparative | Y_{2.36}Gd_{0.6}Ca_{0.04}Fe_{4.523}Sn_{0.04}Al_{0.32}O₁₂ | Ferrite | −0.09 | −0.23 | +23.0 | −6.2 |
| Example 4 | | | | | | |
| Comparative | Y_{1.9}Gd₁Ca_{0.1}Fe_{4.583}Sn_{0.25}Zr_{0.75}Al_{0.2}O₁₂ | Ferrite | −0.09 | −0.20 | +17.0 | −5.1 |
| Example 5 | | | | | | |
| Comparative | Y_{1.9}Gd₁Ca_{0.1}Fe_{4.583}Hf_{0.01}Al_{0.2}O₁₂ | Ferrite | −0.09 | −0.18 | +10.0 | −4.7 |
| Example 6 | | | | | | |

As shown in Table I, the fluctuations in center frequencies in Examples 1 to 3 were substantially the same as those in Comparative Examples 1 to 6. The fluctuations in out-of-band attenuation in Examples 1 to 3 were less than those in Comparative Examples 1 to 6. This is probably because the temperature coefficients of magnetization of the magnetic disks are near to and consistent with the temperature coefficients of residual magnetization of the SmCo-based magnets or the AlNiCo-based magnets, as shown in Table I.

### Experiment 2

Isolators as shown in FIG. 1 were prepared in Example 4 and Comparative Example 7 to examine insertion losses and out-of-band attenuation.

### Example 4

A magnetic disk composed of YIG ferrite of Y_{1.65}Gd_{1.35}Fe_{4.863}Co_{0.01}Si_{0.01}O₁₂ and having an approximately-hexagonal shape, as viewed from the top, of about 1.5 mm long by about 1.87 mm wide by 0.35 mm thick was used as the magnetic disk 5. An SmCo-based magnet as in Examples 1 and 2 was used as a biasing magnet. An isolator of Example 4 as shown in FIG. 1 was prepared with these magnetic disk and magnet. Dielectrics of matching capacitors were composed of barium titanate and had a relative dielectric constant of 160. The capacitance C₁ was 5.3 pF, the capacitance C₂ was 5.9 pF, the capacitance C₃ was 7.8 pF, and the terminal resistance was 75 Ω.

### Comparative Example 7

An isolator of Comparative Example 7 was prepared as in Example 3 except that dielectrics of matching capacitors were composed of lead zirconate (PbZrₓO_{y}) and had a relative dielectric constant of 140. The capacitance C₁ was 4.1 pF, the capacitance C₂ was 4.6 pF, the capacitance C₃ was 8.2 pF, and the terminal resistance was 75 Ω.

Regarding the isolators of Example 4 and Comparative Example 7, insertion losses at 1.88 GHz (fo) and out-of-band attenuation at 3.76 GHz (2fo) were measured. Table II shows the results.

As shown in Table II, there was no large difference between Example 4 and Comparative Example 7 regarding the insertion losses, but the absolute value of the out-of-band attenuation in Example 4 was higher than that in Comparative Example 7.

TABLE II

| | | | Insertion Loss at | Out-of-band |
|---|---|---|---|---|
| | | | Center Frequency fo | attenuation |
| Example | C₁(pF) | C₂(pF) | (dB) | (dB) |
| Example 4 | 5.3 | 5.9 | −0.49 (1.88 GHz) | −22.24 |
| Comparative | 4.1 | 4.6 | −0.47 (1.88 GHz) | −14.78 |
| Example 7 | | | | |

1. A non-reciprocal circuit device comprising:
a magnetic disk;
a plurality of central conductors intersecting each other on a surface of the magnetic disk;
a plurality of matching capacitors connected to the respective central conductors; and
an SmCO-based or AlNiCo-based magnet that is stacked on the magnetic disk, the SmCO-based or AlNiCo-based magnet applying a bias magnetic field to the magnetic disk, wherein the magnetic disk is composed of garnet ferrite represented by the following formula:
Y₃₋ₓGdₓFe_{t-2y-z}Co_{y}Si_{y}Al_{z}O₁₂
where 0.2≦x≦1.5, 0.005≦y≦0.015, 0≦z≦1.5, and 4.75≦t≦5, each of x, y, z, and t indicating a ratio in the formula.

2. A non-reciprocal circuit device comprising:
a magnetic disk;
a plurality of central conductors intersecting each other on a surface of the magnetic disk;
a plurality of matching capacitors connected to the respective central conductors; and
an SmCO-based or AlNiCo-based magnet that is stacked on the magnetic disk, the SmCO-based or AlNiCo-based magnet applying a bias magnetic field to the magnetic disk, wherein the magnetic disk is composed of garnet ferrite represented by the following formula:
Y₃₋ₓ₋ᵤGdₓCaᵤFe_{t-2y-u-z}Co_{y}Si_{y}DᵤAl_{z}O₁₂
where D is at least one element selected from Zr, Hf, and Sn, and 0.2≦x≦1.5, 0.005≦y≦0.015, 0≦z≦1.5, 4.75≦t≦5, and 0<u≦0.3, each of x, y, z, t, and u indicating a ratio in the formula.

3. A non-reciprocal circuit device comprising:
a magnetic disk;
a plurality of central conductors intersecting each other on a surface of the magnetic disk;
a plurality of matching capacitors connected to the respective central conductors; and
an SmCO-based or AlNiCo-based magnet that is stacked on the magnetic disk, the SmCO-based or AlNiCo-based magnet applying a bias magnetic field to the magnetic disk, wherein the magnetic disk is composed of garnet ferrite represented by the following formula:
Y₃₋ₓGdₓFe_{t-2y-v-z}Co_{y}Si_{y}InᵥAl_{z}O₁₂
where 0.2≦x≦1.5, 0.005≦y≦0.015, 0≦≦z≦1.5, 4.75≦t≦5, and 0<v≦0.2, each of x, y, z, t, and v indicating a ratio in the formula.

4. The non-reciprocal circuit device according to claim 1, wherein 0.2≦x≦1.25, 0.005y≦0.01, 0≦z≦1.5, and 4.75≦t≦4.9.

5. The non-reciprocal circuit device according to claim 2, wherein 0.2≦x≦1.25, 0.005≦y≦0.01, 0≦z≦1.5, 4.75≦t≦4.9, and 0.04≦u≦0.2.

6. The non-reciprocal circuit device according to claim 3, wherein 0.2≦x≦1.25, 0.005≦y≦0.01, 0≦z≦1.5, 4.75≦t≦4.9, and 0.04≦v≦0.2.

7. The non-reciprocal circuit device according to claim 1, wherein each of the plurality of matching capacitors comprises a dielectric material having a relative dielectric constant of 150 or more.

8. The non-reciprocal circuit device according to claim 7, wherein the dielectric material is composed of barium titanate.

9. The non-reciprocal circuit device according to claim 2, wherein each of the plurality of matching capacitors comprises a dielectric material having a relative dielectric constant of 150 or more.

10. The non-reciprocal circuit device according to claim 9, wherein the dielectric material is composed of barium titanate.

11. The non-reciprocal circuit device according to claim 3, wherein each of the plurality of matching capacitors comprises a dielectric material having a relative dielectric constant of 150 or more.

12. The non-reciprocal circuit device according to claim 11, wherein the dielectric material is composed of barium titanate.

13. The non-reciprocal circuit device according to claim 4, wherein each of the plurality of matching capacitors comprises a dielectric material having a relative dielectric constant of 150 or more.

14. The non-reciprocal circuit device according to claim 13, wherein the dielectric material is composed of barium titanate.

15. The non-reciprocal circuit device according to claim 5, wherein each of the plurality of matching capacitors comprises a dielectric material having a relative dielectric constant of 150 or more.

16. The non-reciprocal circuit device according to claim 15, wherein the dielectric material is composed of barium titanate.

17. The non-reciprocal circuit device according to claim 6, wherein each of the plurality of matching capacitors comprises a dielectric material having a relative dielectric constant of 150 or more.

18. The non-reciprocal circuit device according to claim 17, wherein the dielectric material is composed of barium titanate.

19. The non-reciprocal circuit device according to claim 1, wherein the magnetic disk, the plurality of central conductors, the plurality of matching capacitors, and the SmCO-based or AlNiCo-based magnet are housed in an approximately-rectangular-parallelepiped magnetic yoke of 3.2 mm or less per side, as viewed from the top.

20. The non-reciprocal circuit device according to claim 2, wherein the magnetic disk, the plurality of central conductors, the plurality of matching capacitors, and the SmCO-based or AlNiCo-based magnet are housed in an approximately-rectangular-parallelepiped magnetic yoke of 3.2 mm or less per side, as viewed from the top.

21. The non-reciprocal circuit device according to claim 3, wherein the magnetic disk, the plurality of central conductors, the plurality of matching capacitors, and the SmCO-based or AlNiCo-based magnet are housed in an approximately-rectangular-parallelepiped magnetic yoke of 3.2 mm or less per side, as viewed from the top.
